(19) United States
(12) Patent Application Publication
(10) Pub. No.: US 2017/0221013 A1
(43) Pub. Date: Aug. 3, 2017

(54) ALTERATION OF DATA ASSOCIATED WITH ELECTRONIC CALENDAR BASED ON WHETHER USE IS ACTUALLY AVAILABLE

(71) Applicant: Lenovo (Singapore) Pte. Ltd., New Tech Park (SG)

(72) Inventors: Arnold S. Weksler, Raleigh, NC (US); Nathan J. Peterson, Oxford, NC (US); Russell Speight VanBlon, Raleigh, NC (US); John Carl Mese, Cary, NC (US)

(21) Appl. No.: 15/010,284

(22) Filed: Jan. 29, 2016

(51) Int. Cl. G06Q 10/10; H04L 29/08; H04W 4/02

(52) U.S. Cl. CPC G06Q 10/1095; H04W 4/027; H04L 67/18

(57) ABSTRACT

In one aspect, a first device includes a processor and storage accessible to the processor. The storage bears instructions executable by the processor to determine whether a user is actually preoccupied with an activity denoted in an electronic calendar. The instructions are also executable by the processor to adjust data pertaining to whether the user is available based at least in part on the determination of whether the user is actually preoccupied with the activity.

### FIELD

The present application relates generally to alteration of data associated with an electronic calendar based on whether a user is actually available.

### BACKGROUND

As recognized herein, the electronic calendar of one person may be accessible to the person's co-workers so that the co-workers may determine whether the user is available for a question or conversation. However, as also recognized herein, often times a meeting indicated in the electronic calendar continues longer then the time allotted for it in the electronic calendar or ends earlier than that time, leading the person's co-workers to believe the person is unavailable when the person is in fact available. There are currently no adequate solutions to the foregoing.

### SUMMARY

Accordingly, in one aspect a first device includes a processor and storage accessible to the processor. The storage bears instructions executable by the processor to determine whether a user is actually preoccupied with an activity denoted in an electronic calendar. The instructions are also executable by the processor to adjust data pertaining to whether the user is available based at least in part on the determination of whether the user is actually preoccupied with the activity.

In another aspect, a method includes determining whether a user is actually preoccupied with an activity denoted in an electronic calendar and adjusting data pertaining to whether the user is available based at least in part on the determining whether the user is actually preoccupied with the activity.

In still another aspect, a first device includes a first processor, a network adapter, and storage bearing instructions executable by a second processor of a second device for determining whether a user is actually available for contact and altering data accessible to at least a third device based at least in part on the determination. The data is associated with whether the user is available, and the first device transfers the instructions to the second device over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart of an example algorithm in accordance with present principles; and

FIGS. 4-12 are user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

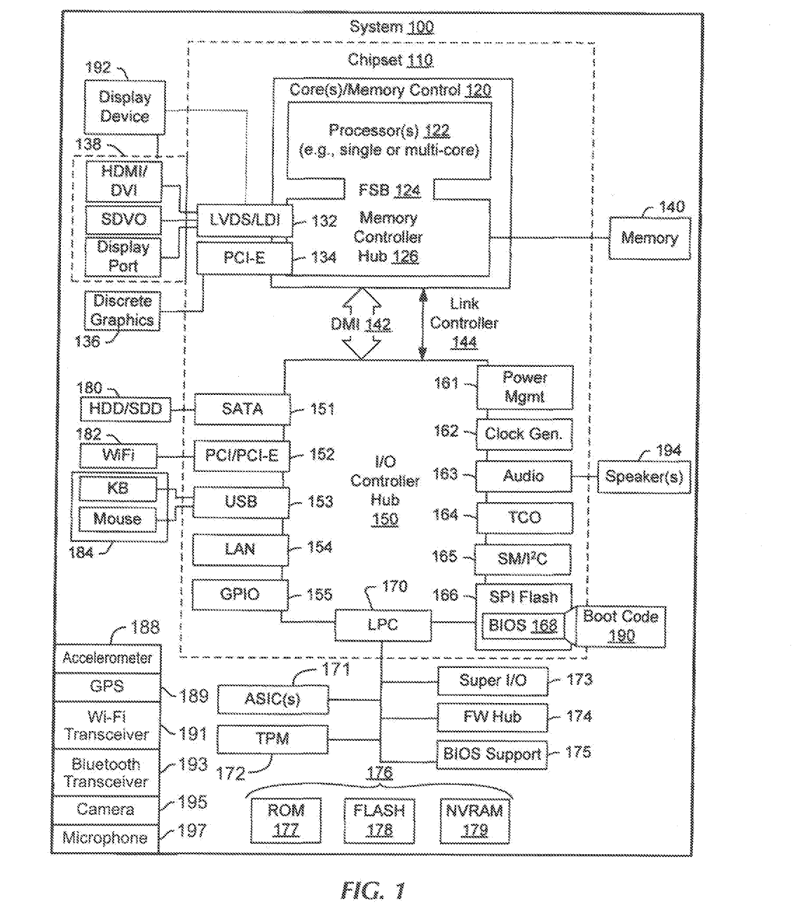

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 50 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCL-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, in some embodiments the system 100 may include an accelerometer 188 that senses acceleration and/or movement of the system 100 and provides input related thereto to the processor 122, as well as a GPS transceiver 189 that is configured to receive geographic position information from at least one satellite and provide the information to the processor 122. However, it is to be understood that another suitable position receiver other than a GPS receiver may be used in accordance with present principles to determine the location of the system 100.

FIG. 1 also shows that the system 100 may include a wireless local area network (WLAN) and/or Wi-Fi transceiver 191 for communicating with other devices in accordance with present principles using WLAN and/or Wi-Fi communication protocols. Still further, the system 100 may include a Bluetooth and/or Bluetooth low energy (BLE) communication element 193 (e.g., a Bluetooth 4.0 communication element) for communicating with other devices in accordance with present principles using Bluetooth communication protocols, as well as a camera 195 that gathers one or more images and provides input related thereto to the processor 122 and an audio receiver/microphone 197 that provides input to the processor 122 based on audio that is detected, such as via a user(s) providing audible input to the microphone 197. Note that the camera 195 may be a thermal imaging camera, a digital camera such as a webcam, a three-dimensional (3D) camera, and/or a camera otherwise integrated into the system 100 and controllable by the processor 122 to gather pictures/images and/or video.

It is to be understood that an example client device or other machine/computer may include fewer or more features than shown on the system 100 of FIG. 1. In any case, it is to be understood at least based on the foregoing that the system 100 is configured to undertake present principles.

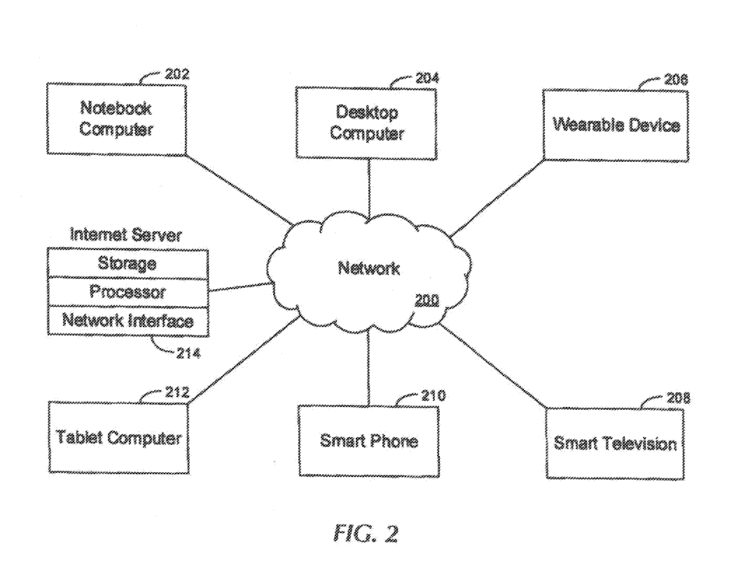

Turning now to FIG. 2, example devices are shown communicating over a network 200 such as the internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

Referring to FIG. 3, it shows example logic that may be executed by a device such as the system 100 in accordance with present principles (referred to when describing FIG. 3 as the “present device”). Beginning at block 300, the logic initiates and/or executes one or more applications for undertaking present principles, such as a calendar application, an application for devices associated with a user to communicate with each other, a Global Positioning System (GPS) application, a map application, etc. From block 300 the logic proceeds to block 302, where the logic allows people (via their own respective devices) to access an electronic calendar associated with the user of the present device and/or to access an availability status indicator/information regarding whether the user is currently available for contact, such as to conduct an in-person conference or to speak telephonically.

From block 302 the logic next proceeds to block 304, where the logic receives and/or processes data from one or more of an accelerometer on the present device and/or on another user-associated device in communication with the present device (such as a smart watch being worn by the user and communicating with a smart phone of the user that is executing the present logic), a GPS transceiver on the present device and/or on the other user-associated device, a Wi-Fi transceiver on the present device and/or on the other user-associated device, a Bluetooth transceiver on the present device and/or on the other user-associated device, a camera on the present device and/or on the other user-associated device, a microphone on the present device and/or on the other user-associated device, etc. From block 304, the logic next proceeds to decision diamond 306.

At diamond 306 the logic determines, based at least in part on the data received and processed at block 304, whether the user associated with the present device is en route to an event or activity noted in a calendar entry in the electronic calendar or otherwise associated the calendar entry. For instance, the logic may periodically parse data in the electronic calendar to identify upcoming events (e.g., events that are to transpire, per their respective calendar entries, within a threshold time of the current time of day), and then identify locations associated with, and potential routes to, the events based on locations specified in the calendar entry, locations specified by the user, locations determined based on a history of similar events that have previously transpired, based on electronic maps, electronic blueprints, or other location-based data (and/or route-providing software applications) accessible to the user's device that indicates potential routes to the location, etc. The logic may then receive and process data at block 304 as described above and then at diamond 306 determine whether, based on the data, the user is en route to the upcoming event or activity.

As one example of how data received at block 304 may be used to determine whether the user is en route to an upcoming event, data from an accelerometer on the present device and/or on another user-associated device that is indicative of movement or non-movement may be processed to determine if the user (while holding or engaged with the device) is moving and in which direction, which in turn may be used to determine whether an identified movement is toward the location of the upcoming event. In some instances, so-called dead reckoning may be used (by executing a dead-reckoning algorithm using the accelerometer data), in which a user's current location (while moving) may be estimated and tracked, and his or her destination also estimated, based on the current direction in which the user is traveling and previous directions of movement that have been tracked as the user travels.

As another example of how data received at block 304 may be used to determine whether the user is en route to an upcoming event, data from a GPS transceiver on the present device and/or on the other user-associated device may be processed to identify a current location of the user, whether the user is moving, and in which direction based on GPS coordinates that are identified by the present device at regular intervals using the GPS transceiver as the user continues to move. The logic may then determine whether any movement that is identified based on GPS coordinates of the user's device that change through time is along a path or route to the location of the upcoming event and hence whether the user is en route to the upcoming event.

Providing yet another example, in some embodiments data from a Wi-Fi transceiver and/or Bluetooth transceiver on the present device (and/or on the other user-associated device) may be processed to regularly identify a current position of the user as the user moves based on communication of the Wi-Fi transceiver (or Bluetooth transceiver) with Wi-Fi access points (or Bluetooth access points), with other Wi-Fi or Bluetooth-enabled devices, etc. and use received signal strength indication (RSSI) principles and algorithms, signal time of flight and angle of arrival principles and algorithms, trilateration principles and algorithms (such as when the location of the access points are known), and/or triangulation principles and algorithms, etc. The logic may then determine whether the user is moving toward the location associated with the upcoming event based on whether the current position of the user's device changes through time and in which direction.

As another example for determining whether the user is en route to an upcoming event based on data from a Bluetooth transceiver on the user's device, the Bluetooth transceiver may communicate with various Bluetooth beacons that the Bluetooth transceiver comes within signal range of as the user moves with his or her device. These Bluetooth beacons may be broadcasting information pertaining to the location of the beacon and/or the area within the signal range of the beacon, and thus this information may be received by the Bluetooth transceiver and used by the present device to identify movement of the device through time as various Bluetooth beacons come within range and whether the movement is along a route to the location of the upcoming event.

Still providing examples of how the logic may determine whether the user is en route to an upcoming event noted in an electronic calendar, data from a microphone and/or camera on a user's device may be used to determine whether a user is en route to an upcoming event using voice and sound recognition principles and algorithms (for data from the microphone) and using object and person recognition principles and algorithms (for data from the camera). For instance, the logic may determine movement of the device based on voices (or sounds from non-human objects) or faces recognized through time as the user moves based on a data feed from the microphone and camera, and identification of respective locations associated with the detected voices, faces, objects, etc. (such as another person's office) to thus track movement of the user as he or she moves past those locations to determine whether the user is en route to the upcoming event.

With the foregoing examples in mind, note that an affirmative determination at diamond 306 causes the logic to move to block 308, which will be discussed shortly. First, however, note that a negative determination at diamond 306 instead causes the logic to move to decision diamond 310. At diamond 310, the logic determines whether the user is already at a location associated with an event noted in an electronic calendar or is otherwise already engaged in the event. The logic may do so in accordance with present principles based on data from an accelerometer (e.g., to dead-reckon that the user has arrived at the location of the event), based on data from a GPS transceiver (e.g., to identify the current GPS coordinates of the device and whether they are the same as the GPS coordinates for a location of the event), based on data from a Wi-Fi and/or Bluetooth transceiver (e.g., to identify the current position of the user as set forth above (e.g., using RSSI or data from a Bluetooth beacon) and hence whether the current position is the same or at least substantially the same as the location of the event), based on data from a microphone (e.g., to identify a certain type or frequency of ambient noise that may be associated with the location of the event or the event itself) and/or from a camera (e.g., to identify a field of view, a room, an object, etc. associated with the location of the event or the event itself), etc. Still in reference to the determination at diamond 310 for whether the user is at the location of the event or engaged in the event, it may also be based on data from a camera and/or microphone that is used to identify one or more people (e.g., using face and voice recognition software, respectively) at a current location of the present device that may then be determined to be participants in the event, such as based on data in the associated calendar entry for the event that specifies event participants, and if a participant in the event is determined to be at the current location, the logic may make an affirmative determination at diamond 310.

Still in reference to diamond 310, note that the determination thereat may also be made using voice recognition software to process signals from the microphone of the user's voice to identify the voice as the user's, and then to identify keywords spoken by the user to determine if they are correlatable to a topic or subject associated with the event, where the topic or subject may have been indicated in or identified from the calendar entry for the event. If the keywords can be correlated to the topic or subject, an affirmative determination may be made at diamond 310, whereas a negative determination may be made if they are not. The determination at diamond 310 may also be made in the affirmative in response to a determination that a particular software application stored on the user's device has been launched or accessed, and/or that a certain document or data set has been accessed, that is correlatable to a topic or subject of the event and/or that the logic determines will be used to participate in the event (e.g., based on key words correlations using data in the calendar entry), such as an affirmative determination being made responsive to a determination that a topic is “document review” and a user's launching of a word processing application (which is determined to be an application for reviewing documents) within a threshold time of the scheduled start time of the event.

As yet another example, telephone calls (including voice over internet protocol (VOIP) calls) participated in by the user (e.g., using the device undertaking the logic of FIG. 3 or another device in communication with the present device) may be monitored to determine whether a user is engaged in the event. For example, if a user initiates or participates in a telephone call within a threshold time of the scheduled start time of the event as indicated in the calendar entry, an affirmative determination may be made at diamond 310 that the user is engaged in the event. As another example, if the calendar entry for the event indicates that certain people will confer telephonically, and/or if the calendar indicates that the event will occur telephonically (such as if event type associated with the event is classified as a telephonic conference or if the calendar entry indicates a telephone number), an affirmative determination may be made at diamond 310 that the user is engaged in the event in response to the user's participation in the telephone call.

Still in reference to diamond 310, note that a negative determination thereat causes the logic to move to block 312, at which the logic continues to allow others access to the user's electronic calendar, availability status indicator, and/or availability status information without altering the calendar, indicator, or information based on the data received at block 304 and/or determinations made at diamond 306 and 310. However, once an affirmative determination is made at diamond 310, the logic proceeds to the aforementioned block 308.

At block 308, the logic determines that the user is preoccupied and/or is unavailable for contact. The logic may thus adjust an associated calendar entry to indicate to others accessing the user's calendar that the user is unavailable (such as by adjusting a start time for the event to include a time before the previously scheduled start time). In addition to or in lieu of the foregoing, at block 308 the logic may also adjust the user's availability status indicator or information to show that the user is unavailable. Examples of such adjustments will be discussed below in reference to FIGS. 4-9.

However, still in reference to FIG. 3, note that after block 308 the logic next proceeds to decision diamond 314. At diamond 314 the logic determines whether the user is en route from the event. The logic may do so at diamond 314 using one or more of the methods described above in reference to diamond 306, mutatis mutandis, to determine whether a user is traveling away from the location of the event, and/or traveling back to another location associated with the user and/or associated with the user being actually available, such as the user's desk or office. Such a location may be associated with the user based on user input specifying as much, based on the user being at the location more than a predetermined number of times, based on the location being tagged as a user's work location, etc. An affirmative determination at diamond 314 causes the logic to move to block 316, which will be described shortly. However, first note that a negative determination at diamond 314 instead causes the logic to move to decision diamond 318.

At diamond 318 the logic determines whether the user is at a location other than the location of the event, such as the location associated with the user or associated with the user being actually available as described above, and/or whether the event has otherwise concluded. The logic may do so at diamond 318 using one or more of the methods described above in reference to diamond 310, mutatis mutandis, to determine a current location of the user based on the location of the device and whether the determined current location matches a user-associated location. The logic may also do so by monitoring a telephone application on the present device and/or a telephone in communication with the present device to determine whether a (e.g., scheduled) telephone call has concluded. The logic may also do so by monitoring a number of people attending the event, such as using input from a camera to identify a number of people shown in one or more images of the event location and/or using input from a microphone to identify a number of people speaking at the event location, and determining that the event has concluded responsive to identification of a change in the number of people at the location, such as relatively less people being at the location than during a majority of the time the event was scheduled to take place.

Note that a negative determination at diamond 318 causes the logic to move to block 320, where the logic may continue to allow others access to the user's electronic calendar, availability status indicator, and/or availability status information without further altering the calendar, indicator, or information from how it was altered at block 308. However, once an affirmative determination is made at diamond 318, the logic proceeds to the aforementioned block 316.

At block 316 the logic determines that the event has concluded, and/or that the user is no longer preoccupied and/or unavailable for contact. The logic may thus adjust the associated calendar entry to indicate to others accessing the user's calendar that the user is available (such as by adjusting an end time for the event to a time before the previously scheduled end time). In addition to or in lieu of the foregoing, at block 316 the logic may also adjust the user's availability status indicator or information to show that the user is now available.

Now in reference to FIGS. 4-7, they show example a user interface (UI) 400 associated with an electronic calendar and indicating information for a portion of a user's schedule for a particular day from 8:00 a.m. to until 12:59 p.m. It is to be understood that the UIs 400, and/or the data indicated therein, may be accessible by other people using their respective devices to determine if the user is available during a particular time he or she would like to contact the user. As may be appreciated from FIG. 4, the user's calendar for this particular day indicates that the user is available from 8:00 to 8:59 a.m., unavailable for being contacted from 9:00 a.m. and 11:00 a.m., and available again from 11:01 a.m. until at least 12:59 p.m. The time the user is unavailable from 9:00 a.m. and 11:00 a.m. (as indicated on the UI 400 as shown in FIG. 4) is understood to be associated with a calendar entry input by the user to his or her electronic calendar during which the user will be unavailable. In some example embodiments, other people may be able to view the content of the calendar entry specified by the user (such as information related to a meeting, a meeting location, and meeting participants), while in other example embodiments the other people may only be able to see that the user is unavailable during the specified time.

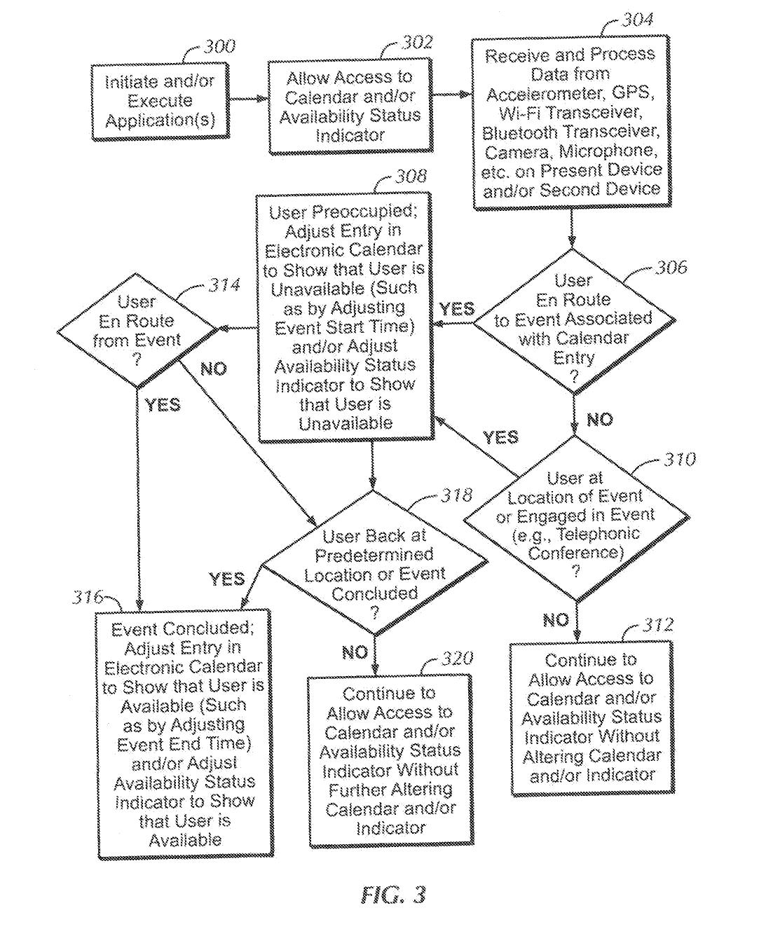

In any case, assume that the user has begun walking at 8:50 a.m. to the event scheduled to start at 9:00 a.m. that day per the user's electronic calendar as represented by the UI 400. Assume a device associated with the user and being taken to the event by the user begins tracking the user's movement in accordance with present principles, such as by executing the logic of FIG. 3 discussed above. The device may determine that even though the scheduled start time for the event has not arrived, the user is traveling to the location of the event and hence is unavailable for being contacted on other matters. Responsive to such a determination, the device may alter the user's electronic calendar to reflect that the user is unavailable from 8:50 a.m. until at least the scheduled end time for the event at 11:00 a.m. Accordingly, once the device alters the user's electronic calendar in this way, the UI 400 viewable to other people will reflect that the user is unavailable between 8:50 a.m. and 11:00 a.m., as shown in FIG. 5.

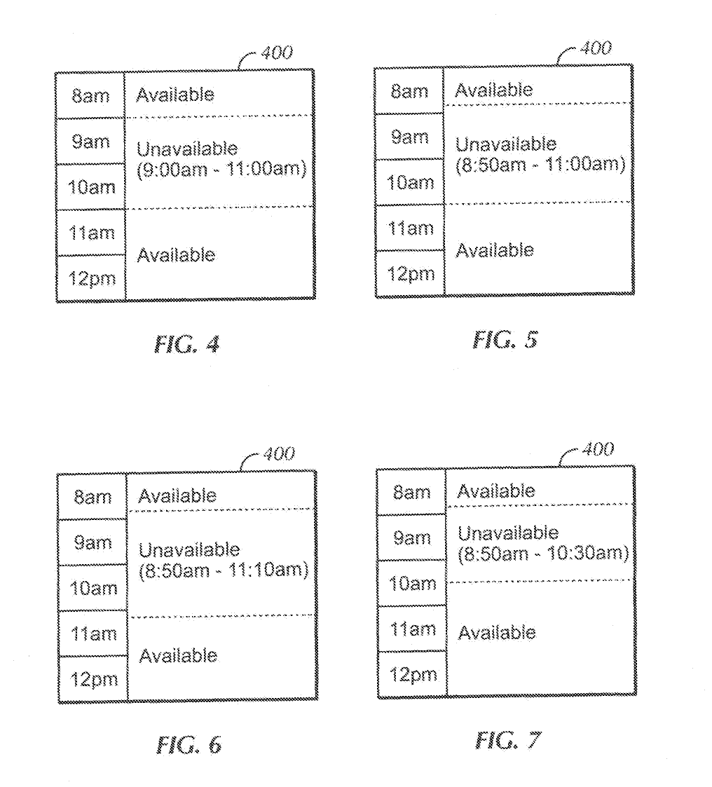

Now assume that the event has concluded, and the user has begun walking back to a predetermined location (such as the person's office), or at least has left the location of the meeting. The user's device may identify as much, and either adjust the user's electronic calendar to show that the user is actually available, or estimate an arrival time back at a location at which the user will actually be available (e.g., based on the user's current rate of travel from the location of the event) and adjust the user's electronic calendar to reflect that the user will be available at the estimated time. FIG. 6 illustrates that the device has adjusted the electronic calendar to indicate that user will be unavailable from 9:00 a.m. until 11:10 a.m. and then available after that, such as if the meeting ended on time but the user still has to walk ten minutes back to his or her office, or if the meeting ended ten minutes late and the device has been configured to adjust the calendar to indicate that the user is available when an event ends regardless of any travel time from the event to another location. FIG. 7 illustrates that the device has adjusted the electronic calendar to indicate that the user will be unavailable from 9:00 a.m. until 10:30 a.m. and then available after that, such as if the meeting ended early as determined by the device.

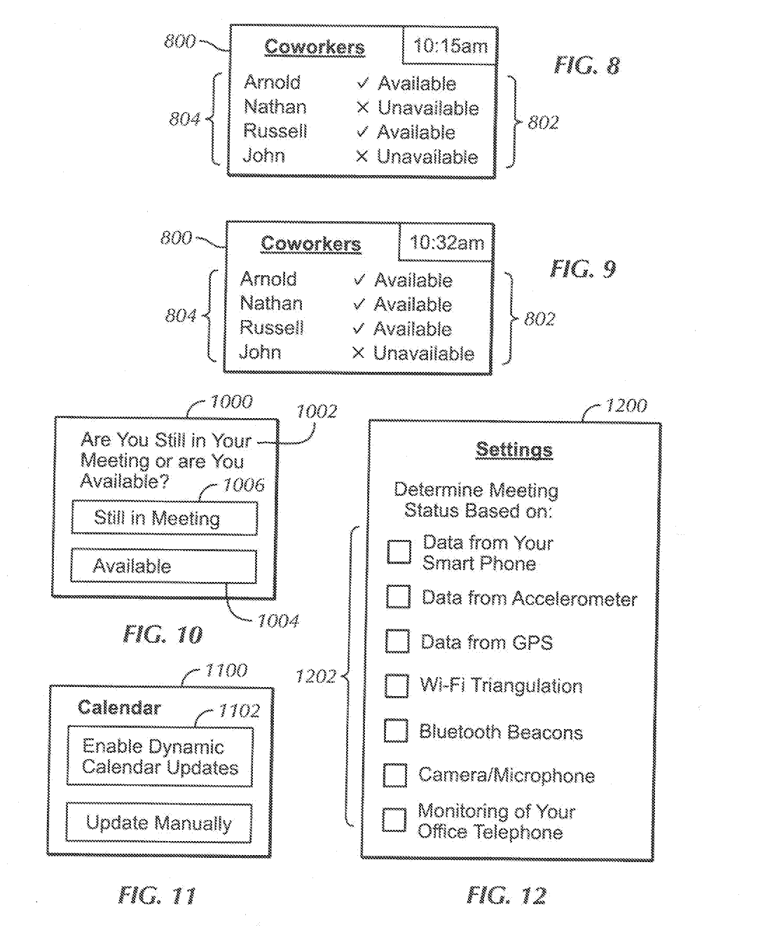

Now in reference to FIGS. 8 and 9, they show an example UI 800 listing example availability status indicators/information 802 associated with various people 804. The indicators 802 may be associated with the respective people's electronic calendars and reflect whether the people are currently available or not based on events entered into their calendars. In some embodiments, the indicators may include an icon, such as a check mark if the respective person is currently available and an “X” if the respective person is currently unavailable, as well as text, such as the word “available” if the respective person is currently available and “unavailable” if the respective person is currently unavailable.

As may be appreciated from FIG. 8, at 10:15 a.m., Arnold and Russell are both available, while Nathan and John are both unavailable. As may be appreciated from FIG. 9, responsive to Nathan's device determining that Nathan is now available in accordance with present principles (such as if Nathan's device determines that Nathan is en route from an event noted in his electronic calendar), Nathan's device may adjust his availability status indicator that is accessible to others to reflect that he is now currently available at 10:32 a.m.

Continuing the detailed description in reference to FIG. 10, it shows an example UI 1000 presentable on a device configured to undertake present principles (e.g., storing code to execute the logic discussed above in reference to FIG. 3) and having access a user's electronic calendar to adjust entries and/or availability status indicators associated therewith. The UI 1000 includes a prompt 1002 asking the user whether her or she is still in a meeting indicated in the calendar or if the user is actually available, which may be presented responsive to the device dynamically determining that the event has concluded in accordance with present principles (e.g., on time or otherwise), such as if the device determined that the user is en route from the event based on data from the device's accelerometer. Thus, it is to be understood that while in some embodiments the device may automatically adjust the user's calendar and/or availability status indicator to indicate that the user is now available without any additional user input, in other embodiments the user may provide input to the UI 1000 by selecting selector 1004 to indicate that the user is now available, which in turn causes the device to adjust the user's calendar and/or availability status indicator from indicating the user is unavailable to indicating that the user is available responsive to receipt of the input directed to selector 1004. However, also note that the user may select selector 1006 to indicate that the user is still unavailable and hence command the device to decline to adjust the user's calendar and/or availability status indicator from its current state of indicating the user is unavailable.

Before moving on to the description of FIG. 11, it is to be understood that responsive to a device undertaking present principles determining that a user is available or unavailable as described herein, and/or in response to the user selecting one of selectors 1004 and 1006, the device may automatically transmit corresponding notifications (such as emails, instant messages, direct messages, text messages, pings, audio notifications, vibration notifications, etc.) respectively indicating whether the user is available or unavailable to other devices, accounts, and/or people that have requested availability status updates. Such notifications may indicate, for instance, that the user has just become available or unavailable, and/or that the user is currently available or unavailable. The notifications may also be in the form of notifications from the device to the user's electronic calendar that is useable by the calendar to update a corresponding entry for an event accordingly.

FIG. 11 shows another example UI 1100 presentable on a device configured to undertake present principles. The UI 1100 is understood to be associated with a user's electronic calendar and is useable to configure the electronic calendar and/or user's device. Specifically, the UI 1100 may be manipulable by a user to configure the user's device(s) to dynamically update calendar entries and/or availability status indicators in accordance with present principles, such as based the logic discussed above in reference to FIG. 3, by selecting selector 1102 (e.g., using touch input to a touch-enabled display on which the UI 1100 is presented). The UI 1100 may also be manipulable by the user to configure the user's device(s) to not dynamically update calendar entries and/or availability status indicators, but instead only do so when a user manually adjusts the entries himself or herself, by selecting selector 1104.

Continuing now in reference to FIG. 12, a UI 1200 is shown that is presentable on a device configured to undertake present principles. The UI 1200 is understood to be associated with a user's electronic calendar and/or the user's device, and is useable to configure how adjustments to the electronic calendar are made. The UI 1200 may be integrated with the UI 1100 or presentable as a separate UI on the user's device. In any case, the UI 1200 may be manipulable by a user to configure the user's device(s) and/or electronic calendar to adjust calendar entries and/or availability status indicators based on various factors 1202 in accordance with present principles. Each factor listed on the UI 1200 is understood to be selectable using the respective check box shown adjacent thereto. As may be appreciated from FIG. 12, these factors 1202 may include using data from another device (other than the present device on which the UI 1200 is presented) such as accelerometer or GPS data from the other device, using data from an accelerometer on the present device, using data from a GPS transceiver on the present device, using data from a Wi-Fi transceiver on the present device (and, e.g., executing Wi-Fi triangulation using the data), using Bluetooth beacons communicating with a Bluetooth transceiver on the present device, using a camera and/or microphone on the present device, and monitoring a telephone associated with the user and in communication with the present device (e.g., for whether the user is engaged in a telephone call and hence unavailable).

It may now be appreciated that present principles provide for a device to determine times that a meeting or event was scheduled to start and stop. The device may then determine, for example, when the user gets up and starts walking to the meeting, and in response to this determination the device may start displaying a “user in meeting” message for others to see, and/or the device may set a “meeting in progress” flag. When the user gets up from the meeting, travels somewhere else, and again stops moving, the device may detect as much and reset the user's status to “user is not in meeting” or “user is now available”. The foregoing can be executed by the device (e.g., a smart watch, cell phone, or other computing device), for example, by monitoring movement via an accelerometer, GPS, Wi-Fi triangulation. Bluetooth beacon, or other means. A user's predetermined or associated location can also be monitored so that when the device detects that the user has returned to their desk or other configured location (such as based on a determination that the user is controlling a desktop computer at the location), the meeting may be considered over.

Furthermore, for “non-physical” meetings such as a conference call participated in by the user at his or her desk without anyone else being physically present at the same location, the device may monitor when the phone call is initiated and when the call is terminated and the “meeting started” and “meeting over” messages may be updated accordingly. A smart watch, cell phone or other computing device may be used to monitor when the call was initiated and terminated.

Additionally, it is to be understood that in some instances, a meeting or event noted in an electronic calendar may be determined (based on location information, for instance) to be going beyond its scheduled end time (e.g., even if the device determines that the meeting is still ongoing and has not concluded) and hence extend into or conflict with another, later scheduled event also noted in the electronic calendar. In such an instance, a device undertaking present principles may alter the start time for the later scheduled event by rescheduling it to begin at a later time (e.g., estimated by the device to be a time at which the user will be available for the next meeting and/or another time at least a threshold amount of time beyond when the earlier meeting was scheduled to end) and update any meeting participants specified in the entry for that later scheduled event accordingly. The participants may be updated by the device automatically providing them with, fir example, an email notification that the user is still in another meeting and will be late, and/or an email notification that the meeting will begin at a later time once the earlier meeting concludes.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

While the particular ALTERATION OF DATA ASSOCIATED WITH ELECTRONIC CALENDAR BASED ON WHETHER USER IS ACTUALLY AVAILABLE is herein shown and described in detail, it is to be understood that the subject matter which is encompassed by the present application is limited only by the claims.

What is claimed is:

1. A first device, comprising:
a processor; and
storage accessible to the processor and bearing instructions executable by the processor to:
determine whether a user is actually preoccupied with an activity denoted in an electronic calendar; and
adjust data pertaining to whether the user is available based at least in part on the determination of whether the user is actually preoccupied with the activity.

2. The first device of claim 1, wherein the determination of whether the user is actually preoccupied with the activity is based at least in part on data from a second device.

3. The first device of claim 2, wherein the data pertains to movement of the second device.

4. The first device of claim 1, comprising an accelerometer, and wherein the determination of whether the user is actually preoccupied with the activity is based at least in part on data from the accelerometer.

5. The first device of claim 1, comprising a global positioning system (GPS) transceiver, and wherein the determination of whether the user is actually preoccupied with the activity is based at least in part on data from the GPS transceiver.

6. The first device of claim 1, comprising a Wi-Fi transceiver, and wherein the determination of whether the user is actually preoccupied with the activity is based at least in part on data from the Wi-Fi transceiver.

7. The first device of claim 1, comprising a Bluetooth transceiver, and wherein the determination of whether the user is actually preoccupied with the activity is based at least in part on data from the Bluetooth transceiver.

8. The first device of claim 1, comprising a camera, and wherein the determination of whether the user is actually preoccupied with the activity is based at least in part on data from the camera.

9. The first device of claim 8, wherein the instructions are executable by the processor to:
process the data from the camera to determine that a number of people at a location has changed; and
determine that the user is not actually preoccupied with the activity in response to the determination that the number of people at a location has changed.

10. The first device of claim 1, comprising a microphone, and wherein the determination of whether the user is actually preoccupied with the activity is based at least in part on data from the microphone.

11. The first device of claim 10, wherein the instructions are executable by the processor to:
process the data from the microphone to determine that a number of people at a location has changed; and
determine that the user is not actually preoccupied with the activity in response to the determination that the number of people at a location has changed.

12. The first device of claim 1, wherein the determination of whether the user is actually preoccupied with the activity is based at least in part on a determination that a telephone call facilitated by the first device has concluded.

13. The first device of claim 1, wherein the determination of whether the user is actually preoccupied with the activity is based at least in part on a determination that a telephone call has concluded that has been facilitated at least in part using a second device in communication with the first device.

14. The first device of claim 1, wherein the data associated with the electronic calendar that is altered comprises data pertaining to whether a user associated with the electronic calendar is available.

15. The first device of claim 1, wherein the data associated with the electronic calendar that is altered comprises data pertaining to an end time for the event.

16. The first device of claim 1, wherein the determination of whether a user is actually preoccupied with an activity denoted in an electronic calendar comprises a determination of whether a user is actually not preoccupied with an activity denoted in an electronic calendar.

17. A method, comprising:
determining whether a user is actually preoccupied with an activity denoted in an electronic calendar; and
adjusting data pertaining to whether the user is available based at least in part on the determining whether the user is actually preoccupied with the activity.

18. The method of claim 17, wherein the data that is adjusted comprises data associated with the electronic calendar pertaining to at least one of a scheduled start time for the activity and a scheduled end time for the activity.

19. The method of claim 17, wherein the data that is adjusted comprises an availability status indicator that is associated with the user.

20. The method of claim 17, wherein the determining whether a user is actually preoccupied with an activity denoted in an electronic calendar comprises determining whether a user is actually not preoccupied with an activity denoted in an electronic calendar.

21. A first device, comprising:
a first processor;
a network adapter; and
storage bearing instructions executable by a second processor of a second device for:
determining whether a user is actually available for contact; and
altering data accessible to at least a third device based at least in part on the determination, the data associated with whether the user is available;
wherein the first device transfers the instructions to the second device over a network via the network adapter.

22. The first device of claim 21, wherein the determining whether the user is actually available for contact comprises determining whether the user is at least one of en route to a location of an event denoted in an electronic calendar and en route from the location.

23. The first device of claim 21, wherein the determining whether a user is actually available for contact comprises determining whether a user is actually not available for contact.
